(19) United States
(12) Patent Application Publication
(10) Pub. No.: US 2012/0296899 A1
(43) Pub. Date: Nov. 22, 2012

(54) Decision Management System to Define, Validate and Extract Data for Predictive Models

(76) Inventor: Bruce W. Adams, West Vancouver (CA)

(21) Appl. No.: 13/472,203

(22) Filed: May 15, 2012

Related U.S. Application Data
(60) Provisional application No. 61/486,598, filed on May 16, 2011.

(51) Int. Cl. G06F 17/30

(52) U.S. Cl. 707/736; 707/E17.005

(57) ABSTRACT

The present invention provides a decision management system to define, validate and extract data for predictive models. A system of sensors is deployed in a sample collection environment, where such sensors are used to collect data from a biological or chemical sample, with additional sensors for ambient data whose output as a form of metadata can characterize performance conditions including background ambient conditions. A format or sequence of processes is the basis for a math model to establish a logical weight to data for predictive modeling and event reporting. The present invention provides a computer or other sensor interface system with a primary sensor or sensors, network connection, and supplementary sensors to measure the conditions in which the primary data is captured. A software process allows for user inputs of data in order to establish the methods and rules for normal function.

### CROSS-REFERENCE TO RELATED APPLICATIONS

This application claims benefit under 35 U.S.C. 119(e) to U.S. provisional patent application Ser. No. 61/486,598, filed May 16, 2011, which is incorporated herein by reference in its entirety.

### FIELD OF THE INVENTION

The present invention pertains to the field of decision management and in particular to predicting the relevance of events from data.

### BACKGROUND

Logical Condition is the simplistic approach to monitoring where given a variable and a boundary, to determine if the variable is within or outside of the bounds and take action based on the result. Look up tables and moving averages are part of event definition. Logical conditions are primarily used to provide alerts and reminders to individuals and have been shown to help increase compliance with many different guidelines. However, historically creating too many alerts and reminders causes people to ignore them altogether. Various other type of pre and post processing of data include artificial neural networks whose disadvantages include time consuming system training. The artificial neural network systems derive their own formulas for weighting and combining data based on the statistical recognition patterns over time which may be difficult to interpret and cause doubts regarding the system's reliability. Bayesian Knowledge-based graphical representation have disadvantages such as the difficulty to get the a-priori knowledge for possible analysis and may not be practical for large complex systems with multiple scenarios. Genetic Algorithms have disadvantages such as a lack of transparency in the reasoning and a challenge in defining the fitness criteria. There must be many components available in order to solve a problem.

Numerous methods to describe state variables have been used describe the “state” of a dynamic system. In simple thermodynamics systems, or mechanical systems, data and their derivatives are typical state variables; knowing these, the future behavior from objects in a system can be projected where the state and history describes enough about a system to determine its future. Predictive data are subject to numerous conditions that have direct impacts on the state of their usefulness.

In biological sample analysis, conventional analysis software can use variable biosample prediction algorithms, it is time consuming and difficult to correlate results with multiple analysis software systems, for instance, each using different algorithms to predict the presence of proteins. Increased confidence could be had in the results, if data could be normalized to absolute values. Conventional experimental parameters of separation of peptides and proteins often report results of one biosample, where the results are a baseline relative to the entire biosample rather than individual well reactions normalized to an absolute value. Shotgun proteomics has known limitations in conventional use and sample analysis, and is often inclusive of using third party data analysis methods with variable results, difficulty in correlation of results and limited access to algorithms.

Therefore there is a need for better predictive data performance, and while there are numerous methods to describe the state of complex systems, extrapolation of data to be used in a reliable business context remains a challenge.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a decision management system to define, validate and extract data for predictive models. In accordance with an aspect of the present invention, there is provided a system deployed in a data acquisition environment, with orthogonal types of analysis whose output include metadata with a reference time code that can characterize performance conditions, background ambient conditions and provide predictive analysis.

In accordance with another aspect of the present invention, there is provided a system deployed in a data acquisition environment, with genetic algorithms whose output as a form of metadata with a reference time code can characterize performance conditions, where a format or sequence of processes is the basis for a math model to establish a logical weight to data, and predictive interpretation and where multiple data variables can be combined to derive such weighting including a data variable model, iterative forward modeling, and a sensor signature model and non rigid patterns and classification of data with a logical process defined relative to the application.

### BRIEF DESCRIPTION OF THE FIGURES

FIG. 1 illustrates a Schematic of System Components

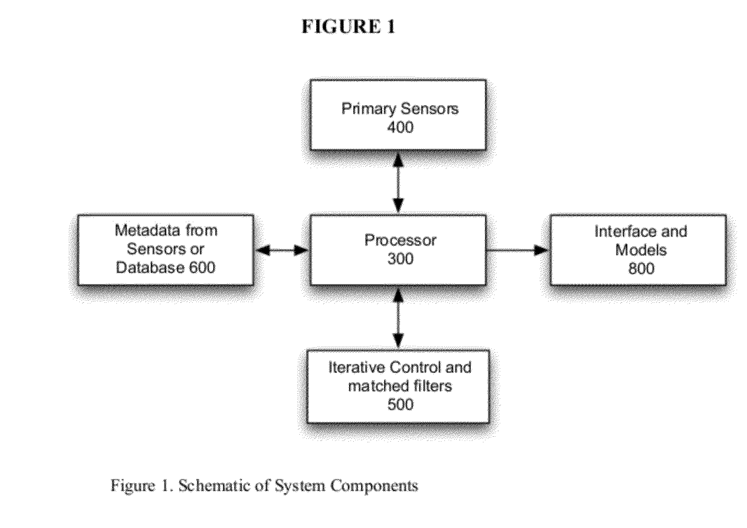

FIG. 2 illustrates a Relevance Processor and its Inputs

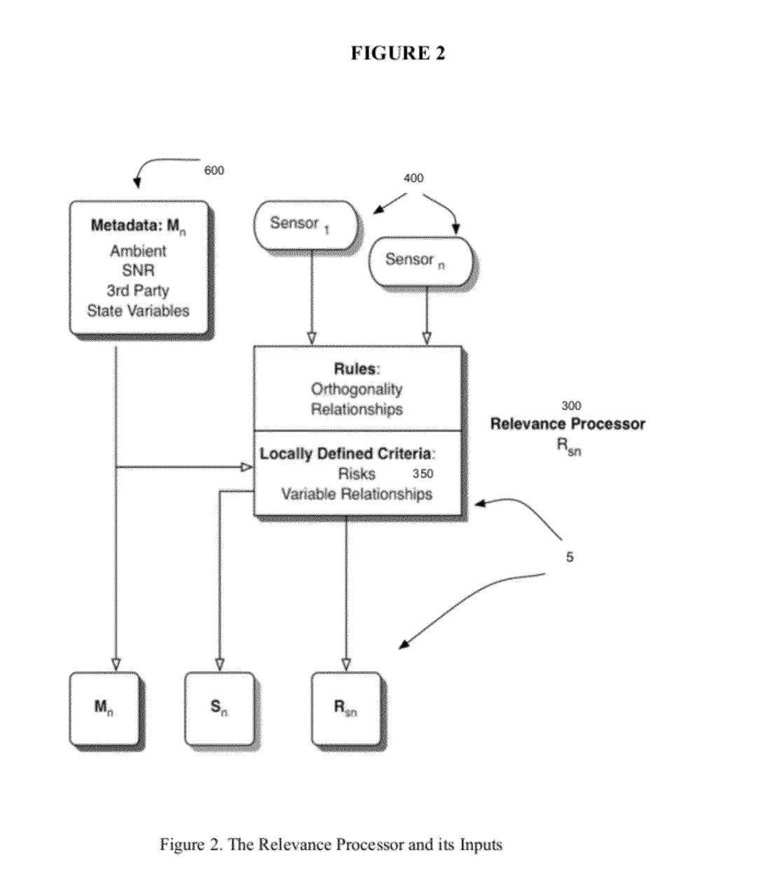

FIG. 3 illustrates a Sensor Signal Model (SSM) processor

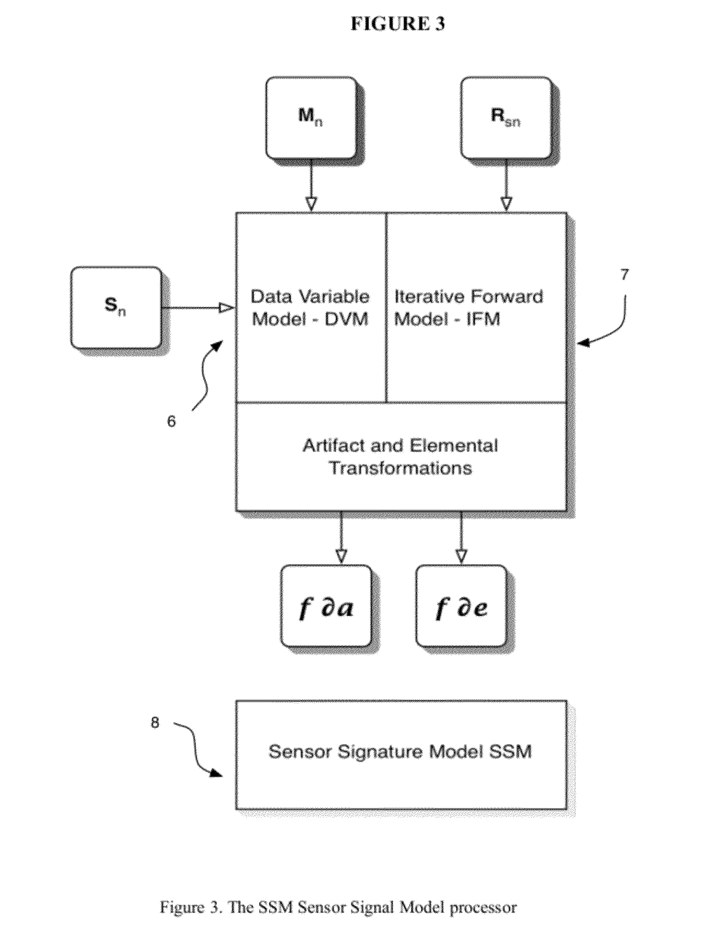

FIG. 4 illustrates the Phases of Operational Functions, Operation Conditions, and Feature Extraction

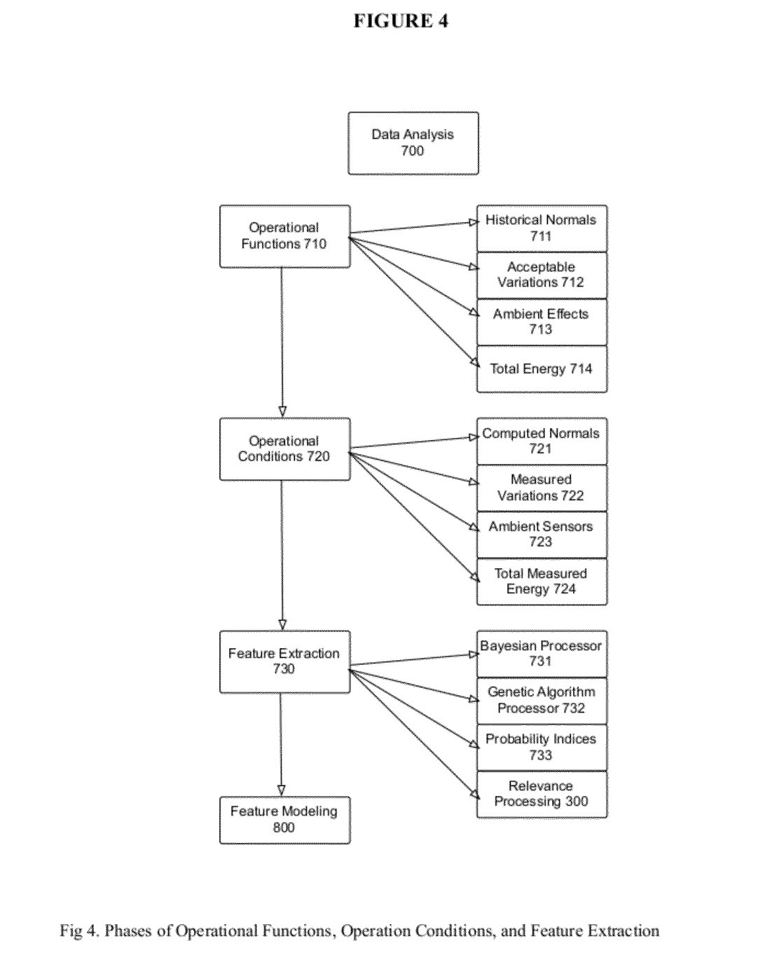

FIG. 5 illustrates the Features of the Predictive Model

FIG. 6 illustrates the data flow created using created by using orthogonal metadata to perform real time algorithm analysis and control of conditions during sample collection.

FIG. 7. illustrates the high level architecture

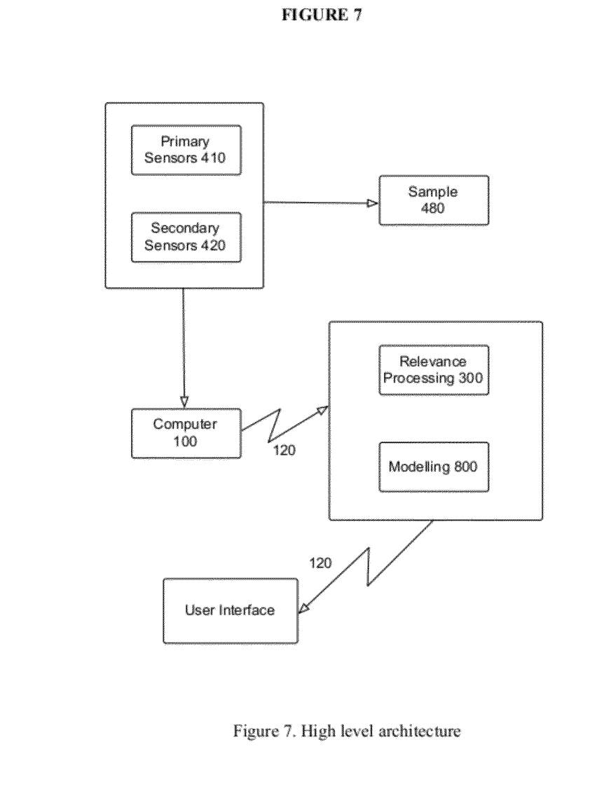

### DETAILED DESCRIPTION OF THE INVENTION

### Definitions

The term “Event” is used to define the Frequency; Amplitude; Duration; Rate of Change in the calculation of quantitative relationships of the data sources in a matrix type calculation

The term “Processor” is used to define the use of various algorithms in combination with operational functions, conditions, feature extraction and modeling; such as the combination of risk and consequences to define events.

The term “Reference Calculations” is used to define the process of implementing decisions about processor interpretation with other empirical evidence and site specific knowledge; and accepting or altering risks in an iterative process.

The term “Sample Collection” is used to define the process of collecting and subsequent laboratory or field processing of a biological or chemical sample with conventional sample bottles and filters, or with more non conventional methods such as with microfludics.

The term “Matched Filter” is used to define the process as would be commonly known in radar and parameter estimation.

The terms “Digital Data” and “Digital Image” and “Data Set” are used to represent the data source and their one dimensional to three dimensional attributes including the use of analog data where appropriate and including layer of metadata or processing data that might be attributed to data or images collected from a sample at a point, or set of points in space at some time or periods of time.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

The present invention provides a computer 100, or other sensor interface system with a primary sensor or sensors 410, network connection 120, and supplementary sensors 420, to measure the conditions in which the primary data is captured. A software process allows for user inputs of data in order to establish the methods and rules for normal function.

The invention will now be described with reference to specific examples. It will be understood that the following examples are intended to describe embodiments of the invention and are not intended to limit the invention in any way.

### Design of a Critical Systems Monitor

The invention is a combination of data mining techniques to be used in combination with small in-situ sensor networks or large geographically separated networks, in a configuration to allow for rapid detection of data anomalies. The application of data to measure the ambient conditions of a subject and subsequently whether the subject is at a higher total energy level, can impact the monitored response from a sensor or sensors 400 such that the data might appear differently than its actual purpose should dictate. In some situations, the performance of a system might be tied to its predicted conditions, and in an iterative system 500 by use of an analysis and processing method 700 so could react in advance to mitigate the impact of ineffectiveness or errors from changes in those conditions.

The inventions require three aspects to analyzing data 700.

First is the identification of operational functions 710.

Second is measuring the operational conditions 720.

Third is the extraction from data of events 730 that can also be used to correlate relevance in a knowledge based context 300.

### Interpretation of Critical Data

### State Variables and Modeling

A number of algorithms using different methods are used to represent the states of a data system and predict change. In an environmental monitoring system it could include continuous measurement of variables such as temperature, vibration, humidity, incident light, time or database entries such as laboratory reports of levels of organic or chemical matter or in drug discovery or molecular systems biology. In a discrete time system the algorithm outputs represents the current state of a system yₙ, where n is the period at which the system is being evaluated. The inputs from secondary sensors can form part of the metadata Mₙ 600.

### Indicators Versus Actual Problem

Predictive algorithms in an artificial neural network process can be used as signs of a situation to establish reference data 620 where measurement of the actual data is not practical. For instance Bayesian and genetic and rule based analysis running in parallel would provide robust and scalable indicators of the conditional status of data in an artificial neural network.

User defined parameters may also be used to impart data into an artificial neural network process. The incorporation of existing data and knowledge can be made using a priori knowledge of the relationships between events and their effects 350. For instance, an artificial neural network is a non knowledge-based adaptive system that uses a form of artificial intelligence, that allows the systems to learn from past experiences/examples and recognizes patterns in information. The inputs to the artificial neural network include the Bayesian data, raw data and iterative data.

### Bayesian Knowledge

A Bayesian knowledge based representation can manage a set of variables and their probabilistic relationships between situation and signs, and it is used as a processor to compute the probabilities of the presence of the possible situations given their signs. The conditional probabilities in primary analysis are singular and represent the probability of a situation given the occurrence of signs. In the preferred embodiment, to reduce interpretive errors, joint conditions are used only for secondary analysis. This is a robust tool to help compute the probability of an event with frequently updated data and consistently processes probabilities as new data is presented. It uses the knowledge and conclusions of experts in the form of probabilities, and leads to decision support as new information is available as it is based on unbiased probabilities. However it is used in situations where specific use cases can be defined as P(A|B) being the probability of A under the condition B.

### Iterative Data

Posterior probability is one common method of integrating data in a learning context and the posterior probability distribution of one variable given the value of another can be calculated with by multiplying the prior probability distribution by the likelihood function and dividing by the normalizing constant commonly written as follows:

$${f}_{X \vert Y = y} ( x ) = \frac{{f}_{X} ( x ) {L}_{X \vert Y = y} ( x )}{{\int }_{- ∞}^{∞} {f}_{X} ( x ) {L}_{X \vert Y = y} ( x ) d x}$$

which gives the posterior probability density function for a random variable X given the data Y=y, where:

ƒX(x) is the prior density of X,

L_{X|Y=y}(x)=ƒ_{Y|X=x}(y) is the likelihood function as a function of x,
∫_{-∞}^{∞}ƒ_{X}(x)L_{X|Y=y}(x)dx is the normalizing constant, and
ƒ_{X|Y=y}(x) is the posterior density of X given the data Y=y.

Iterative functions such as posterior probability density and the conditional probabilities can be combined into a cumulative distribution function that provide weighted connections in the artificial neural network. Used as a processor it consists of points of reference and weighted relationships that in three main layers: Input (data receiver or findings), Output (results or possibilities) and Data Processing. In general a system becomes more efficient with known results for large amounts of data, which can overcome the limitations of a logical condition or Bayesian solution. In the preferred embodiment, the system will provide a method to further integrate data from a rule-based algorithm in order to capture knowledge of domain experts into expressions that can be evaluated known as rules 340. Once enough of these rules have been compiled into a rule base, the current working knowledge can be updated against the rule base by chaining rules together until a conclusion is reached. This will provide the advantages of easily stored data, large amounts of information and rules which will help to clarify the logic used in the decision-making process, and elimination of fully customized program systems while still providing input from experts.

### Genetic Algorithms

Yet further, predictive algorithms used as a processor in an artificial neural network process can be further augmented by genetic algorithms in a non-knowledge based environment that continuously rearranges to form different re-combinations that better represent the patterns in data than in the prior solutions 350.

In the genetic algorithm, a collection of binary strings which encode solutions to an optimization problem, that evolves toward better solutions where the fitness of every solution to provide useful data in the collection is continuously evaluated, multiple solutions are selected from the current population (based on their fitness), and patterns are used to form a new collection. The new collection is then used in the next iteration of the algorithm. The genetic algorithm requires a representation of the solution including expected behavior, physical qualities and a fitness function to evaluate the solution domain. A standard representation of the solution is as a bit array. This is convenient as the arrays are easily correlated due to their fixed size. The fitness function is a correlation of the expected data to the real data, and represents the quality solution. The fitness of the solution is the sum of correlation values of all solutions in the collection. This advantage to the artificial neural network process provides a robust iterative process to produce an optimal solution. The fitness function determines the good solutions and the solutions that can be eliminated and can process incomplete data by making educated guesses about missing data. This improves with every use due to adaptive system learning and provides that added benefit that it does not require large databases to store outcome data with the associated probabilities.

The analysis of cause and effect in the probabilistic network where symptoms and state variable categories are evaluated in context of their relationships, in a system based on this logic will attempt to trace a path from signs all the way to classification, using probability to determine which path is the best fit. Advantages of this are the modeled progression of a situation over time and the interaction between states. A root cause analysis is only valued when it is put in context. Traditional models might not be able to present useful data if an event is measured without it being in context. A priori knowledge and data can be used to qualify the relationship between absolute variations in data and their relative changes to either state variables or other measures and indicators.

One objective of the present invention is to continuously update a priori data using automated methods. Prioritization of data in multiple spatial dimensions such as with optical systems or real time biomarker measurement network system can be made by first referencing changes in probabilities. Other dynamic variables could also be incorporated such as manually input data or sensors.

One objective of the invention is to create reference calculations 721 as a form of metadata with a reference time code. The metadata is used to characterize the conditions of an individual system and to measure the background ambient conditions 723. This would include SNR conditions, and other data that might contribute to measure the normal pattern of operations and interference, prior to a data capture series. The reference calculations or metadata pattern reference would subsequently be representative as a look up table in a relational database or reference algorithm in a semantic network system 720. In some cases, sensor function can be verified using vibration frequencies within a mechanical system to assure that the systems are operating normally. This is especially the case where the measurements involve fluid changes such as water transitioning between the fluid and vapor state, and the interactions between suspended chemical and biological particles during such states and transitions. Measurement of vibrational frequency response may also be attained by the presence of mechanical systems such multiple accelerometers, optical vibration analysis, which could be used to measure the spatially coordinated patterns at various frequencies. Excitation of the biological or chemical material and their relationships can be attained through various means where the excitation represents a signal pulse that can be used in correlation with the analysis methods as a form of matched filter processing. An electro-mechanical transducer such as a piezo electric crystal or linear actuator or optical or acoustic excitation or a combination of any of these can be used to create the signal pulse or be used to impact or initiate a chemical or biological reaction.

One objective of the present invention is to provide a format for a mathematical model for data analysis 700 where a sequence of processes is used to establish the relevance of data to each specific use case. This requires that there are established normal functions 711 and acceptable variations from a standard 712. This would include which variations are considered orthogonal such that a change in one data stream is not necessarily dependent or related to the other. Prioritization of those orthogonal relationships has particular relevance to the interpretation of data. In some cases, the orthogonal data may come from the sensors already used for measuring primary data and include such models as ratio of probability distributions of frequency, amplitude or slope variations from normal 733. Measurement of ambient conditions such as SNR, temperature and accelerometer data noise in the system are used to validate if changes in orthogonal ratios are subject to conditions that might skew the data to yield false readings. This may further include correlation of noise between sensors, a calculation of the total energy in the system 724 and the ratio or relationship between total energy and ambient effects 713. Conditions in a sensor response that is considered to be relevant to a use case can be compared to similar sensors in the vicinity in a network based model.

The method may further include two dimensional imaging such registering sensor data by the at least one processor; and comparing the first and the subsequent digital data on a section by section basis by the at least one processor, examples of such comparison including such as imaging an area on a filter, or individual wells of a multi well analyzer, or the stimulated layers of fluid in a separation medium, or as used in microfluidics, where such registration and comparison represents a data set in a relative frequency and total energy relationship. The system may further include referencing by an at least one processor at least one of spectral changes or optical density at specific spatial coordinates in the first digital data to allow later comparison to changes in subsequent digital data of the region of interest.

The method may further include comparing by the at least one processor, a number of ratios of respective radiant spectral intensity of a number of wavelengths or wavebands in a first optical data set, including spatial distribution, or image. The method may further include comparing by the at least one processor a number of ratios of respective radiant spectral intensity of a number of wavelengths or wavebands in at least one subsequent digital data set. Normalizing may include normalizing a plurality of optical data sets including the first data set by measuring a difference of a spectral distribution between an optical character of the subject of interest in combination with digital or physical normalizing features, where a monotonicity of a number of defined spectral relationships is proximate or exceeds a limit of a normal frequency distribution.

The method may further include establishing a subject specific baseline by the at least one processor which is specific to a subject; and wherein the normalizing is based at least in part on the subject specific baseline first data set and a plurality of sequential data sets, the sequential data or images sequentially captured at various times following a capture of the first digital data. The method may further include determining a number of differences in the dataset region of interest, as the region of interest appears between the normalized data sets including the first data set and the plurality of sequential data sets, by the at least one processor, as part of a biosample analysis. Determining a number of differences may include determining any changes of the region of interest as the region of interest during separation, stimulation or combination with chemical or biological reagents which appear between the digital data as part of the determination of the differences in the region of interest as the region of interest appears between the normalized digital images including the first digital image and the plurality of sequential digital images.

The system may further include generating a probability index by the at least one processor based on a combination of distributed properties of a number of variables including a normalization, measuring and correcting for the total energy associated with a data set correction, a geometric or vector correlation, an optical spectroscopic correction, a signal to noise characterization, or a defined diagnostic protocol. The instructions may further cause the at least one processor to generate a digital model that represents the subject or a region of the subject of interest in n dimensions based on multivariate data sets. The method may further include associating at least one of multivariate data or timeline data to the digital model with a geometric that represents the subject of interest with a visible interface such as in two or three dimensions by the at least one processor.

Data set correction may further include correcting for frequency effects in the data set sample represented in at least the first data set which effects are due to interactions of multivariate data in a time domain sequence, and to cross reference and compare a number of derivatives. Correcting may include correcting for differences in time domain response to at least one of an excitation data set to an emission or imaging data set.

The method may further include registering each of a plurality of digital data sets of measured data from the subject or sample 480, by the at least one processor, including the first digital data, based at least in part on a variation between data layer correlation in a temporal sequence of a plurality of digital datasets from the sample.

The method may further include generating by the at least one processor an analysis comparison of layers in at least the first digital data as a histogram. The method may further include generating by the at least one processor a probability distribution of a sample being abnormal. Generating a probability distribution of a sample being abnormal or out of pattern may include generating the probability distribution of the sample being abnormal based at least in part on a comparison of a normal energy absorption and reflection to a percentage of energy absorption and reflection that is attributable to local excitation or reactivity. A probability distribution of a sample being abnormal may include generating the probability distribution with a probability index that weights at least some digital data according to at least one of a diagnostic value or a comparative amount of change between frequencies, or correlation in a matched filter 500. The instructions may further cause the at least one processor to store the digital data as a multi-layer file, including a first digital data layer that stores and at least a second digital data layer that stores metadata.

The instructions may further cause the at least one processor to reference at least one of frequency changes or energy density at specific coordinates in the first digital data set to allow later comparison to changes in a number of subsequent digital data sets of the region of interest. The instructions may further cause the at least one processor to compare a number of ratios of respective excitation and emission of energy of a number of frequencies or frequency bands in the first digital data set. The instructions may further cause the at least one processor to compare the number of ratios of respective radiant excitation and emission of energy of the number of frequencies or frequency bands in the first digital data set to a number of ratios of a respective excitation and emission of energy intensity of a number of frequencies or frequency bands in at least one subsequent digital data set.

The instructions may further cause the at least one processor to establish a subject specific baseline, and normalized based at least in part on the subject specific baseline the first digital data set and a plurality of sequential digital data sets, the sequential digital data sets sequentially captured at various times following a capture of the first digital data set. The instructions may further cause the at least one processor to determine differences in the region of interest as the region of interest appears between the normalized digital data set including the first digital image and the plurality of sequential digital data set as part of a analysis. The instructions may further cause the at least one processor to determine changes of the region of interest as the region of interest appears between the digital data set as part of the determination of the differences in the region of interest as the region of interest appears between the normalized digital data set including the first digital image and the plurality of sequential digital data sets.

The instructions may further cause the at least one processor to correct for spectral artifacts in the sample data set represented in at least the first digital image which spectral effects are due to interactions of multivariate data in a defined time domain, and to cross reference and compare a number frequency and energy components specified by at least one of a digital model of sample data or other digital data to generate the digital two or three dimensional model of the region of interest 800. The instructions may further cause the at least one processor to correct for differences in priority orientation of at least one data set to display a representation of the datasets in an interface.

The instructions may further cause the at least one processor to generate an analysis comparison of layers in at least the first digital data as a histogram. The instructions may further cause the at least one processor to generate a probability distribution of a sample being abnormal. The instructions may further cause the at least one processor to generate the abnormal relationship of the data viewed within a probability index that weights at least some digital data according to at least one of a diagnostic value or a comparative amount of change between frequency and energy.

In one embodiment of the system, a processor is used for anomaly detection and is used to define data that can identify compliance violations and other operational risks. This combined with contextual event processing and enables real-time identification and alerting of anomalies within applications, database and or network activity. An occurrence of an event can be made from naturally occurring changes or by stimulating or enhancing the subject of interest to determine its state including the detection, monitoring and surveillance. An event can also be considered based on its probability based other related changes such as the likelihood of one event based on the occurrence of another as is typical for surrogate biological indicators in public health whereby a probability may be interpreted as a risk with potential consequences. In such a case risk management is used to define the process of implementing decisions about risk Interpretation with other empirical evidence and site specific knowledge; and accepting or altering risks in an iterative process.

### Normalization

In some embodiments, the data processing host computer system may normalize a data time series (i.e., temporal 20 sequence of data). Such digital data may have been captured over a relatively long time at any variety of frequencies or intervals, and/or over a relatively short time at any variety of frequencies or intervals. In the case of multiple data samples analyzed over variable ambient conditions, any difference of the spectral distribution between the character of data, such as those analyzed with dispersive optical systems versus data created with structured laser light, such as a 3D scanner, will reduce the probability of confidence in a data correlation.

For analysis with optical measures, the presence by measure of reflective, absorptive, transmissive or fluorescent light, or relationship of one spectra to another is computationally bounded within certain limits of what is normal. Normal may be determined by the spectral distribution ratios of the subject of interest or in comparison to a time series, or across a population of similar measures. Once there has been a normalization, certain optical relationships can be analyzed such as a probability distribution. In the case where spectral distribution is corrected by numerical methods, a computed distribution that results in increases of a waveband that might normally cause fluorescence will not be able to assign fluorescent values outside of what is considered normal. However, by analysis the distribution can be automatically assessed by the sample image processing host computer system to determine if there are corresponding increases in spectra that would relate to absorption and fluorescence. To correct for fluorescence in a time series of numerically processed digital images requires then that the digital images are assessed or analyzed within a probability index. Some embodiments may advantageously employ digital images that are displayed in layers assigned to the wavebands of excitation and with a probability index that allows certain images to be weighted in their diagnostic value. The monotonicity of spectral changes, whether individual spectra or comparative changes between spectra may show a trend; for instance, a trend that highlights a decreasing amount of reactivity in one sample versus another sample. The sample image processing host computer system may consider or assess a linearity of the function versus the normalization.

### Validating and Securing the Data

The relevance data models 300 are broken down as follows:

Data Variable Model (DVM) 6 or ∂: calculation or measurement of application-specific data signatures and impacts for each selected variable from the group of data linearity, repeatability, resolution, sensitivity, specificity, drift, offsets, signal noise and further including performance characteristics and maintenance requirements.

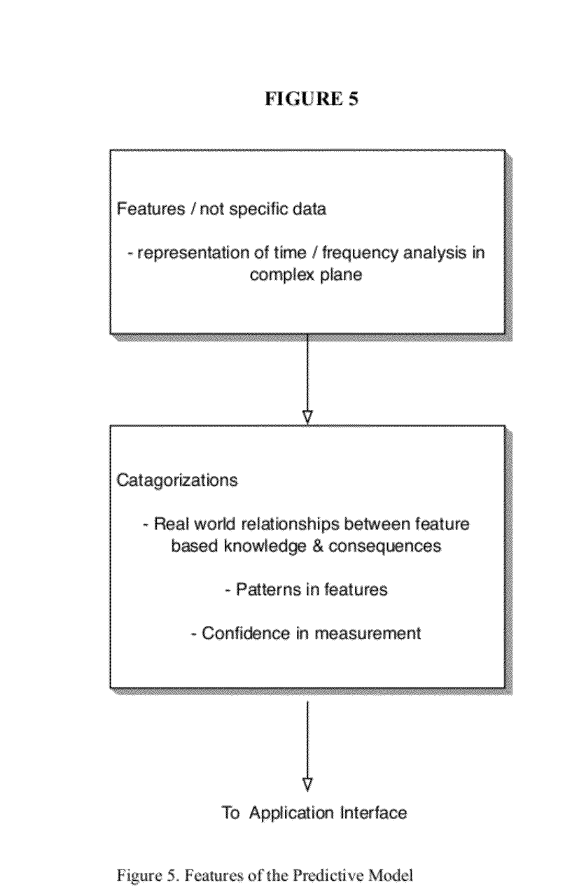

Iterative Forward Modeling (IFM) 7: The combination of all of the DVM variables over time to create iterative models of both the artifact ∂a and normal or elemental ∂e data. Incorporation of the ∂a and ∂e IFM's as delta response signatures that define the probable sensor responses with data computational functions, including the predictive, FIG. 5, or real time impacts of empirical knowledge or data, combined into a learning model that will define the normal at-sensor response signature.

Sensor Signature Model (SSM) 8: Transformation of at-sensor ∂a and ∂e IFM signatures into two validated functions, f∂a and f∂e that together are the SSM. By using the SSM over time the resulting delta response values are directly transformed to baseline normalized and signature balanced values.

While SNR signal to noise ratio have typically been used to describe the values for the definition of sensor performance, the measure of SNR typically falls short of describing the overall systems performance. The Sensor Signature Model (SSM), on the other hand, describes critical variable specific signatures that do not depend entirely on the noise level of a sensor.

Operational functions 710 include parameter estimation and the standard operational guidance as noted by system specifications and reporting requirements as required to define the variable for the DVM. Operational conditions 720, including environmental considerations and normal usage about specific sensor characteristics can be integrated, including the duty cycles, resolution, and sampling intervals. An installation sampling interval will take into account the undefined data of each variable at the DVM definition phase. Feature extraction 730 include the derivation of normalized signatures requires that all application and variable requirements be normalized to specified levels. The approach considers the likely frequency distribution model of each variable and the specified probable range levels minimum, median, maximum per variable, excluding non-significant ranges. SSM operation 8 include the parameters in the reporting model, the SSM, can now be inferred as the difference between f∂a and f∂e parameter and their variations. The relation between the artifact signatures and the normal operation is used to derive minimal, median, and maximal levels based on all the variables per application. A probability distribution is thus more accurately considering all the variables in the model before the reporting of any anomalous event. The resolution of a sensor should be equal to or better than the difference of SSM f∂a and f∂e derived signatures.

### Normalization of Values.

For interpretation of measured events, people generally wish to have data displayed as dependent upon on a specific absolute reference value, for instance the reporting of water turbidity in NTU. It is often incorrectly assumed that a measured signal is linearly related to the amplitude of an event. Sensors may respond linearly however, artifacts caused by ambient conditions may have impact within the detection bandwidth such as vibration on an optical system or out of band such as temperature on a photodetector and either case may impact sensor detection differently than the quantum efficiency of true signal in a given integration time. The impacts of multiple variables can also impact the accuracy and repeatability of such reporting. For instance with a high sensitivity easily saturated optical sensor, a square root function may be used in the noise normalization if the noise of a sensor were known to increase as the square of the data amplitude. However artifacts can cause substantial increases in sensor response without having any impact on SNR. This is especially the case with variations in ambient conditions that impact the sensor environment and can include variables such as temperature, humidity and vibration.

Evaluation of SNR values might be more reasonably described as their relative variation from the median range signal level rather than an absolute value. Estimated system noise could also be weighted on median response and not on minimum response. Thus if SNR behavior is patterned with signal response, it is the changes from the pattern of what is normal that is weighted and not the actual value of the SNR.

The signature where data response is minimal and SNR and artifacts can have significant impacts are the most critical. A corresponding normalization function would then disregard any sensor response where the impact of f∂a vs. f∂e reports a SSM value that is not valid. In this model detectability is given not given by the smallest signal, but rather by the smallest signatures that can be detected and corrected. In this way, data errors are not included in an iterative model of the sensor site.

The signatures of all the variables need to be combined for an overall view of the response requirements. Further definition of what data should be excluded should also be evaluated.

Less value can be derived for sensors where the artifact variables show a significant deviation from normal. The artifact signatures can be interpreted to noise equivalent responses with which impact sensor performance. Furthermore, sensor resolution may vary with the type of artifact and at-sensor data could be normalized before being incorporated in the f∂e function. This could further prevent skewed data becoming part of the ongoing monitoring and reporting process.

For automation of the calculation that compares the relative signature strength, the maximum, minimum and medians continue to be defined in an ongoing process that excludes of weights differently, data whose SSM signatures reduce the relevance of the data to the problem. The exclusion limits or weighting are an important factor for the combination of heterogeneous data and artifact signatures. The continuous analysis of various data support the iterative process that sets suitable limits to preserves certain data features while excluding non-significant signatures.

### Combination Process

The signatures of the sensor variables can be combined for the derivation of corrected data and its associated relevance probability Rₛₙ 5. The combination is done based on the values that remain after an exclusion process. Accordingly, insignificant signatures with almost disappearing functions are excluded from further analysis. The derived functions that correlate to critical respective data points are used to normalize the signature to the median level. The median level is a typical response gathered over a period of time where data can be best suited for calibration purposes. Short term impacts such as electromagnetic interference can be compared to calibration and maintenance requirements.

The SSM derived and normalized signatures now need to be combined to report standard scientific measures that are well understood. With variables of low significance excluded to achieve realistic requirements, data that demonstrates that f∂a/f∂e within acceptable ratios are included. Determination of this acceptable reporting requirement requires calibrating the monitoring system itself in order to assure that the model is working as the system is given more autonomy to be self correcting.

### Dynamic Range.

Minimum, median, and maximum levels are first derived for each application. Furthermore, the minimum and the maximum expected data at a 0% and 100% event are included. The generic minimal, median, and maximal radiance levels are combined from the corresponding application specific values as sensor dependent absolute minimum, generic median, and absolute maximum for all the applications. The median value is taken as the median of all application specific medians, since all applications can be weighted equally only by this kind of combination.

### Delta Values at Median

The signatures will smooth the data and act as digital filters to remove noise around the median level, hence, the uncertainty of the final results can be substantially compared with the median case. This allows for cross comparison and even cross calibration in combination with all the variables.

The system contains a model for analysis of variable specific relationships between data and data artifacts. The model can be applied to numerous types of sensors and systems however the focus is to combine low cost ambient sensors that would provide information that would supplement SNR calculations. One object of the invention is to assure that uncertainties be included when translating data into performance or scientific measures.

Uncertainty in itself might be an input as the combination and integration of sensor data results in parameters that do not correlate with the anticipated probabilities. One object of the invention then is to provide an iterative process that allows for sensor data and its variables to be interpreted and adjusted so that data can be managed or corrected in a pre-processing environment, rather than in a post processing, database environment.

Feature Extraction from a Data Stream

In the most common case, the data y is described as variations from a baseline normal over time x. A probability distribution f(y) can describe the variations from normal. However when high frequency variations from normal cease to allow the relationships between the data and the function of what is being measured to support the description of normal, then there is a need to describe the data in other ways, in conjunction with f(y).

Outside of the definition of normal there is a rule based system that describes the state variables including properties such as vibration, position, temperature, humidity, pressure, internal energy, enthalpy, entropy.

### Multi Parameter Variations

The relevance of data may also vary with the degree of change over time between periods ∂=(f(y)/xₙ)/(f(y)/x₁), however, the relevance may be rule base and interpretive for various scenarios requiring weighting of variables and may be iterative such as part of a self adjusting system.

Multiple variables with multiple weightings and in multiple time scales or lack of linearity in the relevance between changes of data variables point to further requirement for a rule based system.

The data f(y) may be part of a total data acquisition where y>>f(y) and any relevant data would appear to be buried in signal noise. However the time evolution of a function may be more relevant than the f(y)/y component and the equivalence to momentum in the data over time can be derived from first principles of statistical mechanics using time dependent projection operators and can be described with a Fokker-Plank equation.

The characterization of a zero and first order system can be made in a manner similar to the thermodynamic laws. In the zero order the system is said to be in equilibrium and its properties do not change over time, for instance being characterized as the distribution of events where the data y falls within one standard deviation of the baseline. The first order is the certainty (Cert) by characterization of the system energy as might be interpreted as the systemic noise and the time domain characterization of the data within a certainty of normal. The second order is the (Corr) correlation of system dynamics between systemic noise and reported data.

Multivariate Case with Various Sensors.

When dealing simultaneously with more than one random variable the joint cumulative distribution function can also be defined. For example, for a pair of random variables Y₁, Y₂, the joint cumulative distribution function (CDF) is given by:

(Y₁,Y₂)→f(y₁)/f(y₂)=Probability that ∂y₁=∂y₂

Where every multivariate CDF is:

Monotonically non-decreasing for each of its variables; Right-continuous for each of its variables; The third order is the measure of uncertainty and the lack of correlation.

U=√Cert²+Corr²

### Predictive Models and Approximations

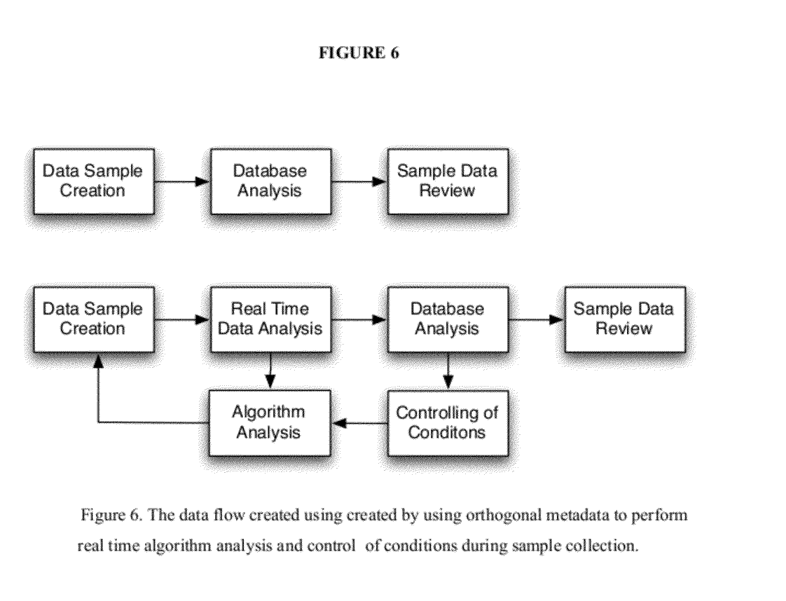

One objective of the invention is to provide a method for pattern classifications based on groups of measurements and observations in a manner that is not rigid. Classification requires that concepts have to have their logical process defined relative to the application domain and employed in order to define the concepts in terms of rules, restrictions, and properties including Time/Frequency Domain Analysis in the Complex Plane. It is another objective to the invention to apply Classification of data analysis such that the presentation layer is obvious, intuitive and simple. This means presenting data in context with known and relative factors within a use case. The result is to represent knowledge within heterogeneous domains based on reasoning and semantic dependencies rather than strict data relationships. To represent those relationships, hierarchical categorization or equality-relations are applied. A categorization will distinguish between orthogonal, FIG. 6, and non orthogonal groups data streams and related groups will inherit properties from their superordinates.

To extract knowledge by inferring relationships has real world consequences and must be given a degree of confidence. Such confidence can come from inputs from real world results and as such it is one objective of the invention to apply confidence levels to various results based on their performance over time. For example, two algorithms might be used to represent change in data relationships, one that looks at probabilities over a short term and one over a long term. In order to say we have more knowledge about the reported changes, some real world event must be presented in correlation. For instance, a boiler may have been tampered with and there would be a significant change in accelerometer data followed by a change in the pattern of the data. The short term analysis would be sensitive to the short term tampering but not the change in pattern. The long term analysis would filter out the tampering event but be sensitive to the change in pattern. In this case we have reported both and change in two domains from the same sensor. From a first event some knowledge can be inferred and a pattern can be established for 0 order pattern recognition and confidence assignment.

### Documents Formats and Data Display

The series of algorithms and their use represent a protocol or a standard analysis and a format of common structure for using sample data for a predictive analysis. It also represents the style for which a set of documents for such analysis can be performed. These documents may be in the form of images or formats for a class of sample. This further simplifies the task of creating and interpreting multiple scans by providing a predefined set of options within which data can be reviewed.

In one embodiment the invention provides an analysis that can be used as a document graphic or multi dimensional computer graphic representation, of the sample data compared with various interactions of the different algorithms indicating the basis, or root cause of the probability analysis.

### EXAMPLES

### Example 1

A System for monitoring protein changes in fluid is described that uses multiple sensors throughout a controlled experimental system. The protein sensor might be a system for spectroscopic analysis, and the ambient metadata sensors would consist of measurements for temperature, vibration, humidity and flow. Changes to the system could include the inclusion of biomarkers and reagents that would interact with the target protein. After a deployment period there would be an apparent pattern between the ambient conditions such as temperature and humidity and the spectral analysis. Variations in flow or vibration would not have similar correlations. A set of rules would establish the normal relationships and the probability of changes being relevant to changes in the target proteins.

### Example 2

A monitoring system for contamination of fluids, especially air or water is described that uses a combination of filters and post analysis where the chemical or biological matter on a filter surface is compared to the probability of such filter conditions. Metadata can be created from analysis of the filter surface and from prior knowledge of the filter sampling conditions such as prior laboratory tests. The expert system can extrapolate the probability of certain conditions where chemical or biological markers of change can act as surrogate indicators. Other metadata sensors such as optical scatter can be used to verify well measurement parameters.

### Example 3

An analysis system to evaluate apriori collected data to analyze chemical and biological drug interactions in a controlled environment where the data has been collected in a conventional manner, but has not been evaluated for probabilities that suggest a positive outcome in terms of probability. In the preferred embodiment, the adaptive changes of the algorithm would serve as one of the inputs to the predictive nature of the output, providing searchable metadata, such as results of event correlation as another method of noise reduction.

### Example 4

A monitoring system that scans a sample of a biological or chemical filter or a multi well assay analysis, where the data processing can be used in real time to characterized the reactivity of a sample with other characteristics such as ambient conditions of the time related application or a chemical or biological reagent, and where the imaging process can then adapt by means of changing data processing or controlling optical or other analysis means in order to better capture the data of interest.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A system comprising primary sensors deployed in a sample collection environment, with sensors for ambient data whose output as a form of metadata with a reference time code can characterize performance conditions including background ambient conditions where a metadata pattern reference would subsequently be representative as a look up table in a relational database or reference algorithm in a semantic network system and where metadata is collected from one or more additional sensors from the group consisting of an accelerometer, a temperature sensor, humidity, atmospheric pressure, fluid flow, fluid condition such as ultrasound or an electro-mechanical transducer such as a piezo electric crystal or linear actuator or optical position measurement where such sensors are used to collect data from a biological or chemical sample.

2. The system in claim 1 deployed in a sample collection environment, with sensors for ambient data whose output as a form of metadata with a reference time code can characterize performance conditions including background ambient conditions where a format or sequence of processes is the basis for a mathematical model to establish a logical weight to data and include such models as ratio of probability distributions of frequency, amplitude or slope variations from normal.

3. The system in claim 1, deployed in a sample collection environment, with sensors for ambient data whose output as a form of metadata with a reference time code can characterize performance conditions including background ambient conditions and where there is a data variable model, iterative forward model, and a sensor signature model.

4. The system in claim 1 deployed in a sample collection environment, with sensors for ambient data whose output as a form of metadata with a reference time code can characterize performance conditions including background ambient conditions where a format or sequence of processes is the basis for a math model to establish a logical weight to data, and where an excitation energy is used to correlate measured changes in ambient conditions with a matched filter post processor.
